(19) United States
(12) Patent Application Publication
(10) Pub. No.: US 2013/0249342 A1
(43) Pub. Date: Sep. 26, 2013

(54) Cantilevered Rotor Magnet Support

(71) Applicants: Stephen J. FUNK, Blacksburg, VA (US); Ethan L. FILIP, Christiansburg, VA (US)

(72) Inventors: Stephen J. FUNK, Blacksburg, VA (US); Ethan L. FILIP, Christiansburg, VA (US)

(73) Assignee: Kollmorgen Corporation, Radford, VA (US)

(21) Appl. No.: 13/424,579

(22) Filed: Mar. 20, 2012

(51) Int. Cl. H02K 1/27

(52) U.S. Cl. 310/156.53

(57) ABSTRACT

A multilayer laminated rotor mountable on a shaft for rotation relative to a stator of a rotary electric machine arrangement has a plurality of laminas joined together to form the rotor and voids for receiving magnets. The rotor has an annular section, extending between a shaft opening for receiving the shaft and a radially outer circumferential rotor surface, which includes an undulating series of the voids in void groups extending from the radially outer circumferential rotor surface inwardly toward the shaft opening and then back toward the radially outer circumferential rotor surface. A pair of distal voids in each void group, together with distal voids of adjacent void groups, define gaps separating adjacent arc sections of the radially outer circumferential rotor surface. Such an arrangement forces the structural support to be cantilevered, improving rotor integrity, and, due to a reduction in magnetic leakage pathways, provides improved electrical performance.

Cross-reference is made to commonly assigned, co-pending U.S. patent application Ser. No. 13/215,296, filed Aug. 23, 2011, titled MAGNETIC ROTOR HAVING INSET BRIDGES TO PROMOTE COOLING.

### BACKGROUND OF THE INVENTION

1. Field of the Invention

This invention concerns a multilayer laminated rotor configuration usable in a rotary electric machine arrangement.

2. Description of Related Art

U.S. Pat. No. 3,979,821 to Noodleman discloses a permanent magnet rotor lamination having openings adapted to receive pieces of magnet material. Each of these openings has lips or flanges adapted to retain a respective magnet material piece in place.

U.S. Pat. No. 5,162,686 to Royer concerns a rotor having magnets held radially in place by extensions of magnetic poles, laminations, or pockets.

U.S. Pat. No. 7,436,096 to Guven et al. relates to an electric machine including a rotor with permanent magnets arranged in clusters or groups adjacent an outer rotor perimeter.

U.S. Pat. No. 6,340,857 to Nishiyama et al., U.S. Pat. No. 6,525,442 to Koharagi et al., U.S. Pat. No. 6,700,288 to Smith, U.S. Pat. No. 6,703,743 to Kaneko et al., U.S. Pat. No. 6,794,784 to Takahashi et al., U.S. Pat. No. 7,504,754 to Jahns et al., U.S. Pat. No. 7,687,957 to Ochiai et al., U.S. Pat. No. 7,847,456 to Kori et al., U.S. Pat. No. 7,851,958 to Cai et al., U.S. Pat. No. 7,902,710 to Han et al., and U.S. Pat. No. 7,952,249 to Kori et al. may also be of interest.

The disclosures of U.S. Pat. Nos. 3,979,821 to Noodleman, 5,162,686 to Royer, and 7,436,096 to Guven et al. are all incorporated herein by reference in their entireties as non-essential subject matter.

### SUMMARY OF THE INVENTION

A multilayer laminated rotor according to this invention is mountable on a shaft for rotation relative to a stator of a rotary electric machine arrangement and has a plurality of laminas joined together to form the rotor with voids for receiving magnets. The rotor has an annular section, extending between a shaft opening for receiving the shaft and a radially outer circumferential rotor surface, which includes an undulating series of the voids in void groups extending from the radially outer circumferential rotor surface inwardly toward the shaft opening and then back toward the radially outer circumferential rotor surface. A pair of distal voids in each void group, together with distal voids of adjacent void groups, define gaps separating adjacent arc sections of the radially outer circumferential rotor surface.

The voids may be arranged in a variety of ways, although, in each arrangement, it is intended to have webs disposed between adjacent voids in each of the void groups support portions of the rotor defining the arc sections primarily in a radial direction of the rotor, and to have portions of the rotor defining the arc sections connected to a central rotor portion solely by webs disposed between adjacent voids in each of the void groups. A central permanent magnet received in a central one of the voids in at least one of the void groups, for example, may be wider than other magnets in that void group. Some of the voids in each of the void groups may be interconnected, moreover, and at least one of the webs may be located centrally with respect to at least one of the void groups. None of the webs needs to be located centrally with respect to any of the void groups, however.

Although it is contemplated that the voids will have an approximately rectangular configuration in a plan view, other void geometries could be used, and the undulating series of voids mentioned extends circumferentially completely around the rotor. The invention additionally concerns a lamina to be included in a multilayer laminated rotor such as that referred to.

### BRIEF DESCRIPTION OF THE DRAWINGS

FIG. 1 is a schematic plan view of an end of a rotor that supports permanent magnets according to the invention.

FIG. 2 is an enlarged view of a portion P of a rotor lamina at the end of the rotor shown in FIG. 1.

FIG. 3 is an enlarged view similar to that of FIG. 2 but of a lamina with a different magnet receptacle arrangement.

FIG. 4 is an enlarged view similar to that of FIG. 2 but of a lamina with another magnet receptacle arrangement.

FIG. 5 is an enlarged view similar to that of FIG. 2 but of a lamina with still another magnet receptacle arrangement.

FIG. 6 is a further enlarged view of a portion Q of the rotor lamina shown in FIG. 2 without the magnets being shown.

### DETAILED DESCRIPTION OF THE INVENTION

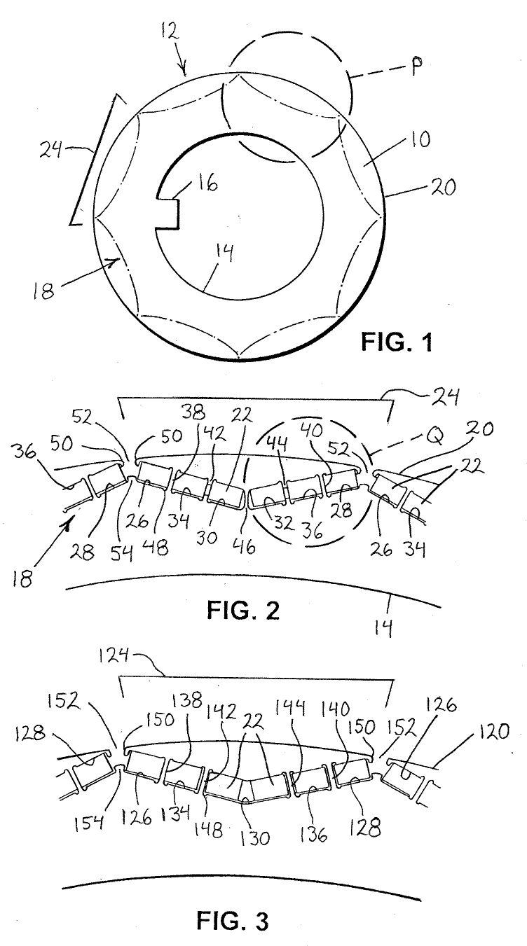

An interior permanent magnet rotor lamina 10 used in production of a multilayer laminated rotor according to the present invention is shown, in plan view, in FIG. 1. It will be understood by those of ordinary skill in the art that the lamina 10 shown in FIG. 1 is an endmost lamina of multiple (e.g., fifty) laminas joined together in a lamination stack to produce the rotor 12 constituting part of a rotary electric machine arrangement, such as a motor, generator, or motor/generator. The laminas may be stamped from sheets of steel or other suitable material. A rotor shaft (not shown) is receivable within a shaft opening 14 of the rotor 12 to impart rotational motion to the rotor. A radially inwardly projecting tooth or key 16 may be used in conjunction with a corresponding recess in the rotor shaft to help secure the rotor 12 against rotation relative to the rotor shaft.

Each lamina 10 has an annular section surrounding the shaft opening 14 and extending between that shaft opening 14 and a radially outer circumferential surface of the overall rotor 12. The annular section is provided with a series 18 of magnet receiving holes, voids, or orifices (hereafter referred to as voids for simplicity) located adjacent a radially outer lamina surface. When the laminas 10 are joined together in a stack to collectively define the rotor 12, the voids of adjacent laminas align and are located near the radially outer circumferential rotor surface 20. As will be described in connection with FIGS. 2-6, permanent magnets 22 are receivable within the voids. The permanent magnets 22 may be inserted into the voids after the laminas 10 are joined together, or, if desired, the voids may be aligned with the magnets 22 as the laminas 10 are slid over the magnets 22 so that the magnets 22 serve as guides to position the laminas 10 properly during rotor construction. Once a selected number of laminas 10 have been joined together, the magnets 22 have been potted, glued, or otherwise secured in place, and the laminated rotor 12 is completed, the permanent magnets 22 extend axially relative to the rotor 12 through the aligned voids of the stack of laminas 10 to a desired extent. The magnets 22 thereafter remain fixed within the voids to cooperate with windings disposed around poles of a stator, within which the overall rotor 12 is rotatable.

As FIG. 1 shows, the series 18 of voids undulates, and is composed of a multiplicity of void groups 24. Each void group 24 extends from the radially outer circumferential rotor surface inwardly toward the shaft opening 14 and then back toward the rotor surface 20. The series 18 extends circumferentially completely around the lamination and, therefore, the rotor including that lamination. In the arrangement illustrated in FIGS. 1 and 2, each void group 24 includes a pair of opposite distal voids 26, 28, a pair of opposite proximal voids 30, 32, and a pair of opposite intermediate voids 34, 36. In this particular arrangement, each of the distal voids 26, 28 is separated from an adjacent intermediate void 34, 36 by a respective web 38, 40 of lamina material. Each of the proximal voids 30, 32, however, is separated from its adjacent intermediate void 34, 36, by flanges, nubs or bumps 42, 44, defining partial webs, such that the sets of proximal and adjacent intermediate voids are actually interconnected. The adjacent proximal voids 30, 32, in each void group 24 are separated from each other by a middle web 46 located centrally with respect to that void group. The voids, shown as approximately rectangular in the plan view provided by FIG. 2, may include recessed fillets 48 at some or all of their corners for optimal stress concentration properties. Other void geometries, of course, could be used. Certain features of this particular arrangement are more clearly illustrated in the enlarged view provided by FIG. 6.

Typically, a rotor lamina utilizing a “buried magnet” design will have a continuous radially outer circumferential surface, such that the material of the rotor lamina fully encircles all magnets in the voids of each void group. In each of the embodiments of this invention, however, as will be described, rotor lamina material is removed from or left out of the outer diameter region of the distal voids in each void group. Avoiding the presence of this rotor lamina material has a structural benefit, as it eliminates rotational hoop stresses from the typically thin outer sections of the lamination webs, and instead forces the structural support to be cantilevered. With this configuration, the remaining webs provide support primarily in the radial direction.

Referring once again to FIG. 2, the series 18 of voids is arranged in such a way that, throughout the rotor 12, the distal voids 26, 28 of adjacent void groups 24 are located next to each other. The distal voids 26, 28 in each of the void groups 24, together with distal voids of adjacent void groups, define gaps 52 separating adjacent arc sections of the radially outer circumferential rotor surface 20. These adjacent arc sections of the rotor surface 20 are accordingly separated by the gaps 52, which may be produced by machining away or leaving out rotor material between the adjacent arc sections. Although such a construction leaves the distal voids 26, 28 open and exposed, flanges, nubs, bumps, or other protrusions 50 of material at adjacent ends of the rotor surface arc sections and common interior flanges, nubs, bumps, or other protrusions 54 of material located between the distal voids 26, 28 help in positioning and retaining magnets 22 within the voids 26, 28. Thus, instead of having support webs fully encircling the permanent magnets, the support web is eliminated from the gaps 52 at the outer diameter region of the rotor. By distributing the gaps 52 around the radially outer circumferential surface 20 of the rotor 12, a modified rotor lamination geometry resulting in reduced stress and improved performance at high rotational speeds is provided. Absence of rotor material in the gaps 52 has a structural benefit, as such a configuration, again, removes rotational hoop stresses from the typically thin outer sections of the rotor laminations, and instead forces the structural support to be cantilevered. Thus, in the arrangement illustrated in FIG. 2, the remaining webs 38, 40, and 46 advantageously provide support primarily in the radial direction, and the added benefit of improved electrical performance, due to a reduction in magnetic leakage pathways, is also provided by the gaps. Different types of void series patterns, of course, can be utilized; such patterns, for example, could be roughly v-shaped, similar to that of the series 18, roughly u-shaped, or flat.

FIG. 3 illustrates an alternative void group arrangement. Here, each void group 124 includes a pair of opposite distal voids 126, 128, a single, v-shaped proximal void 130, and a pair of opposite intermediate voids 134, 136 disposed between the proximal void 130 and the distal voids 126, 128. Each of the distal voids 126, 128 is separated from an adjacent intermediate void 134, 136 by a respective web 138, 140 of lamina material, while the proximal void 130 is separated at opposite ends from its adjacent intermediate voids 134, 136 by respective webs 142, 144 of lamina material. There is no web separating adjacent magnets 22 received within the v-shaped proximal void 130 in this particular arrangement. In other respects, the arrangement shown in FIG. 3 is essentially the same as that shown in FIG. 2. The voids once again may include recessed fillets 148 at some or all of their corners to optimize stress concentration.

Accordingly, the series of voids is configured in the arrangement shown in FIG. 3 so that, throughout the rotor, the distal voids 126, 128 of adjacent void groups 124 are located next to each other. Adjacent arc sections of the rotor surface 120 are separated by gaps 152, which may be produced by machining away or leaving out rotor material between the adjacent arc sections. Flanges, nubs, bumps, or other protrusions 150 of material at adjacent ends of the rotor surface arc sections and common interior flanges, nubs, bumps, or other protrusions 154 of material located between the distal voids 126, 128 help in positioning and retaining magnets 22 within the voids 126, 128. Again, instead of having support webs fully encircling the permanent magnets, the support web is eliminated from the gaps at the outer diameter region of the rotor. By distributing the gaps 152 around the radially outer circumferential surface 120 of the rotor, the rotor lamination geometry results in reduced stress and improved performance at high rotational speeds. As before, absence of rotor material in the gaps 152 has a structural benefit, as such a configuration removes rotational hoop stresses from the typically thin outer sections of the rotor laminations, and instead forces the structural support to be cantilevered. Once again, the remaining webs 138, 140, 142 and 144 provide support primarily in the radial direction, and improved electrical performance, due to a reduction in magnetic leakage pathways, is provided.

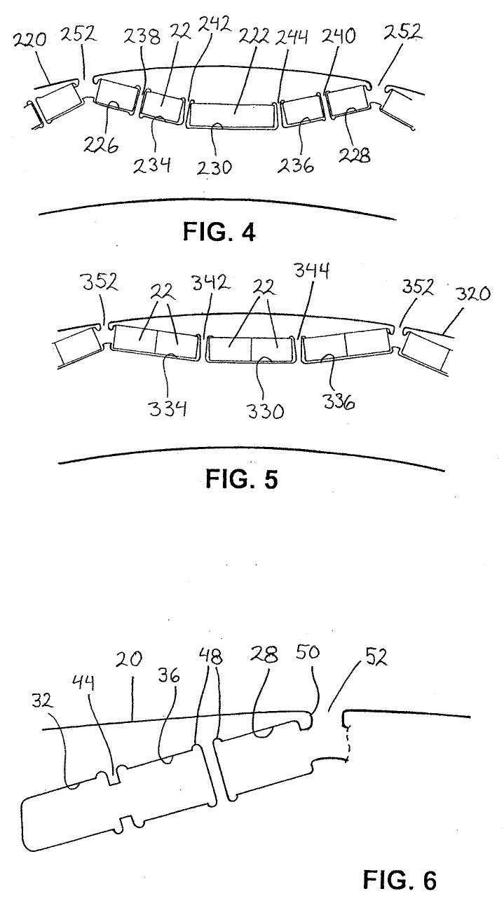

Another void group arrangement is shown in FIG. 4. The arrangement shown in FIG. 4 is essentially the same as that shown in FIG. 3, except that the single, elongated proximal void 230 shown in FIG. 4 is rectangular in plan view rather than v-shaped, and can receive a wider unitary magnet 222. The voids 226, 228, 234, and 236 shown in FIG. 4 are, respectively, essentially identical to the voids 126, 128, 134, and 136 shown in FIG. 3, and carry magnets 22. Due to the presence of the elongated void 230, the void series pattern of FIG. 4 is best described as roughly u-shaped. Gaps 252 are distributed around the radially outer circumferential rotor surface 220, and webs 238, 240, 242, and 244 provide support primarily in the radial direction. Improved electrical performance due to a reduction in magnetic leakage pathways is again provided.

Yet another void group arrangement is shown in FIG. 5. The arrangement shown in FIG. 5 is similar to that shown in FIG. 4, except that each of the voids 330, 334, and 336 shown in FIG. 5 is rectangular and can receive a pair of directly adjacent, contacting magnets 22 or, if desired, a unitary magnet of greater width. Gaps 352 are distributed around the radially outer circumferential rotor surface 320, and webs 342 and 344 provide support primarily in the radial direction. Improved electrical performance due to a reduction in magnetic leakage pathways is once again provided.

The present invention thus provides a rotor lamination geometry that allows for reduced mechanical stress and reduced electromagnetic degradation from magnet support webs. This geometry allows for higher speed, higher performance electric motors and generators. In contrast to conventional laminated rotor designs utilized with buried permanent magnets, with support webs fully encircling the permanent magnets, the modified rotor lamination geometry of this invention reduces stress and improves performance at high rotational speeds. By eliminating a support web from the outer diameter region of the rotor, rotational hoop stresses are removed from the typically thin outer web sections. The structural support is forced to be cantilevered, and the remaining webs provide tensile support primarily in the radial direction of the rotor. The invention can be used with a number of different magnet segments in both flat, v-, and u-orientation shapes, as noted, and only a few examples, which are not intended to be limiting, have been described above.

The foregoing disclosure has been set forth merely to illustrate the invention and is not intended to be limiting. Modifications of the disclosed embodiments incorporating the spirit and substance of the invention may occur to persons skilled in the art, and the invention should be construed to include everything within the scope of the invention ultimately claimed.

1. A multilayer laminated rotor, mountable on a shaft for rotation relative to a stator of a rotary electric machine arrangement, having a plurality of laminas joined together to form the rotor with voids for receiving magnets, the rotor comprising:
an annular section surrounding a shaft opening within which the shaft is receivable, the annular section extending between the shaft opening and a radially outer circumferential rotor surface, the annular section including an undulating series of the voids in void groups extending from the radially outer circumferential rotor surface inwardly toward the shaft opening and then back toward the radially outer circumferential rotor surface,
wherein a pair of distal voids in each void group, together with distal voids of adjacent void groups, define gaps separating adjacent arc sections of the radially outer circumferential rotor surface.

2. The rotor of claim 1, wherein webs disposed between adjacent voids in each of the void groups support portions of the rotor defining the arc sections primarily in a radial direction of the rotor.

3. The rotor of claim 1, wherein portions of the rotor defining the arc sections are connected to a central rotor portion solely by webs disposed between adjacent voids in each of the void groups.

4. The rotor of claim 1, wherein at least a central permanent magnet received in a central one of the voids in at least one of the void groups is wider than other magnets in the at least one of the void groups.

5. The rotor of claim 1, wherein at least some of the voids in each of the void groups are interconnected.

6. The rotor of claim 3, wherein at least one of the webs is located centrally with respect to at least one of the void groups.

7. The rotor of claim 3, wherein none of the webs is located centrally with respect to any of the void groups.

8. The rotor of claim 3, wherein at least one of the webs is located centrally with respect to each of the void groups.

9. The rotor of claim 1, wherein each of the voids has a substantially rectangular cross section.

10. The rotor of claim 1, wherein the undulating series of voids extends circumferentially completely around the rotor.

11. A lamina to be included in a multilayer laminated rotor, mountable on a shaft for rotation relative to a stator of a rotary electric machine arrangement, with voids for receiving magnets, the lamina comprising:
an annular section surrounding a shaft opening, the annular section extending between the shaft opening and a radially outer circumferential lamina surface, the annular section including an undulating series of the voids in void groups extending from the radially outer circumferential lamina surface inwardly toward the shaft opening and then back toward the radially outer circumferential lamina surface,
wherein a pair of distal voids in each void group, together with distal voids of adjacent void groups, define gaps separating adjacent arc sections of the radially outer circumferential lamina surface.

12. The lamina of claim 11, wherein webs disposed between adjacent voids in each of the void groups support portions of the lamina defining the arc sections primarily in a radial direction of the lamina.

13. The lamina of claim 11, wherein portions of the lamina defining the arc sections are connected to a central lamina portion solely by webs disposed between adjacent voids in each of the void groups.

14. The lamina of claim 11, wherein at least a central one of the voids in at least one of the void groups is wider than other voids in the at least one of the void groups.

15. The lamina of claim 11, wherein at least some of the voids in each of the void groups are interconnected.

16. The lamina of claim 13, wherein at least one of the webs is located centrally with respect to at least one of the void groups.

17. The lamina of claim 13, wherein none of the webs is located centrally with respect to any of the void groups.

18. The lamina of claim 13, wherein at least one of the webs is located centrally with respect to each of the void groups.

19. The lamina of claim 11, wherein each of the voids has a substantially rectangular cross section.

20. The lamina of claim 11, wherein the undulating series of voids extends circumferentially completely around the lamina.
